(19) United States
(12) Patent Application Publication
(10) Pub. No.: US 2018/0076471 A1
(43) Pub. Date: Mar. 15, 2018

(54) FUEL CELL AND METHOD OF MANUFACTURING THE FUEL CELL

(71) Applicant: HYUNDAI MOTOR COMPANY, Seoul (KR)

(72) Inventors: Chi Seung LEE, Seongnam-si (KR); Young Woo NOH, Guri-si (KR); Seung Ah YU, Incheon (KR); Jae Jun KO, Gunpo-si (KR); Jang Ho JO, Yongin-si (KR)

(21) Appl. No.: 15/378,390

(22) Filed: Dec. 14, 2016

(30) Foreign Application Priority Data
Sep. 9, 2016 (KR) 10-2016-0116247

(51) Int. Cl. H01M 8/04089; H01M 8/0232

(52) U.S. Cl. CPC H01M 8/04089; H01M 2008/1095; H01M 8/0232

(57) ABSTRACT

A fuel cell includes a membrane electrode assembly including a first electrode layer formed at one side of an electrolyte layer and a second electrode layer formed at another side of the electrolyte layer, a metallic forming body compressed after being form-molded, the metallic forming body being stacked on at least one of the first and second electrode layers, and the metallic forming body supplying reaction gas to at least one of the electrode layers through inner pores, and a bipolar plate stacked on the metallic forming body.

### CROSS-REFERENCE TO RELATED APPLICATION

This application claims the benefit of priority to Korean Patent Application No. 10-2016-0116247, filed on Sep. 9, 2016 with the Korean Intellectual Property Office, the disclosure of which is incorporated herein by reference.

### TECHNICAL FIELD

The present disclosure relates to a fuel cell and a method of manufacturing the fuel cell. More particularly, the present disclosure relates to a fuel cell capable of improving voltage reduction phenomenon of an open circuit, and a method of manufacturing the fuel cell.

### BACKGROUND

In general, a fuel cell is an energy generator in which fuel gas reacts with oxidizing gas to convert chemical energy of fuel into electric energy. The fuel cell includes a plurality of cells generating electric energy through electrochemical reactions of fuel gas and oxidizing gas.

Each cell of the fuel cell may include a membrane-electrode assembly (MEA) and bipolar plates (BPs) disposed at both sides of the membrane electrode assembly. A reaction flow path supplying reaction gas such as fuel gas i.e., hydrogen and oxidizing gas i.e., air (or oxygen), to the membrane electrode assembly and a cooling flow path distributing cooling water are formed at the bipolar plates.

Furthermore, gas diffusion layers (GDLs) for diffusing reaction gas are stacked on both sides of the membrane electrode assembly.

The conventional fuel cell unit cell will be explained in detail. The membrane electrode assembly, which is a main component, is disposed at the innermost each unit cell of the fuel cell.

The membrane electrode assembly includes a solid polymer electrolyte membrane transferring hydrogen ions, and first and second electrode layers, namely, a cathode and an anode, functioning as a catalyst capable of reacting hydrogen with oxygen at both sides of the electrolyte membrane.

In addition, gas diffusion layers (GDL) are stacked at outer parts of the membrane electrode assembly, namely, at outer parts of the first and second layers. Bipolar plates (BPs) for supplying reaction gas (fuel gas, i.e., hydrogen and oxidizing gas, i.e., oxygen or air) while forming a flow path through which cooling water passes are disposed at outer sides of the gas diffusion layer.

Furthermore, a gasket for sealing fluid is interposed between the bipolar plates. The gasket may be provided to be formed at the membrane electrode assembly or the bipolar plates in an integrated manner.

For example, when one bipolar plate disposed at one side of the membrane electrode assembly is referred to as an anode bipolar plate and the other bipolar plate disposed at the other side of the membrane electrode assembly is referred to as a cathode bipolar plate, a channel between the gas diffusion layer adhering to the anode of the membrane electrode assembly and the anode bipolar plate may be an anode channel where fuel gas, i.e. hydrogen flows.

Furthermore, a channel between the gas diffusion layer adhering to the cathode of the membrane electrode assembly and the cathode bipolar plate may be a cathode channel where oxidizing gas, i.e., air (or oxygen) flows. A space between the cathode bipolar plate and the anode which are stacked and adhere to each other, namely, a space forming a bipolar plate land part between the adjacent anode channels and between the cathode channels may be a cooling channel.

A plurality of cells is formed by stacking the above-described unit cells. End plates are coupled to outermost cells in order to support the cells. The cells, which are stacked between the end plates, are coupled to the end plates using a stack coupling unit, thereby constituting the fuel cell stack.

Herein, since each unit cell maintains a low voltage upon operation, in order to increase voltage, tens to hundreds of cells are stacked in series to form a stack, thereby forming a generator.

Meanwhile, to maximize performance of the fuel cell, a width of the reaction flow path of the bipolar plate is allowed to be narrow to equalize a surface pressure of the gas diffusion layer and the membrane electrode assembly and to have uniform penetrability of the gas diffusion layer throughout the entire reaction.

However, to prevent various defects generated in a molding process of the bipolar plate, a decrease of a width of the reaction flow path of the bipolar plate may be limited.

Furthermore, in terms of a cell structure of the fuel cell including the bipolar plate having the flow path, a pitch (a channel width and a land width) of the flow path is limited due to limitations of molding and manufacturing.

To this end, it is known that a porous flow path is applied instead of the bipolar plates in order to uniformly disperse surface pressure, to improve diffusion performance of reaction gas and to improve discharge performance of water.

For example, a method of inserting a metallic forming body formed of porous body is known. In the case that the metallic forming body for providing a porous flow path is used, a pitch of the flow path is allowed to be narrow in comparison with a flow path having a channel structure.

However, in terms of the cell structure of the fuel cell including the metallic forming body, when the metallic forming body in an initial state of manufacture is directly applied to the cell of the fuel cell, a component which is directly in contact with the metallic forming body may be damaged due to a high surface roughness of the metallic forming body.

In addition, in the cell structure of a general fuel cell, the gas diffusion layer having a thickness of hundreds of micrometers may function as a buffer capable of preventing damage to the membrane electrode assembly. However, in the cell structure of the fuel cell including a microporous layer having a thickness of dozens of micrometers, it is difficult for the microporous layer to function to prevent damage to the membrane electrode assembly due to the metallic forming body, such that voltage loss of the open circuit due to damage to the membrane electrode assembly is inevitable.

Furthermore, when the membrane electrode assembly is damaged, endurance degradation of the electrolyte layer may be caused by crossover in which gas passes through the damaged part.

The above information disclosed in this Background section is only for enhancement of understanding of the background of the disclosure and therefore it may contain information that does not form the prior art that is already known in this country to a person of ordinary skill in the art.

### SUMMARY

Therefore, the present disclosure has been made in view of the above problems, and it is an object of the present disclosure to provide a fuel cell including a metallic forming body to prevent damage to a membrane electrode assembly due to a high surface roughness of the metallic forming body, thereby improving voltage loss of the open circuit of the conventional case, and a method of manufacturing the same.

In accordance with one aspect of the present disclosure, the above and other objects can be accomplished by the provision of a fuel cell including a membrane electrode assembly including a first electrode layer formed at one side of an electrolyte layer and a second electrode layer formed at another side of the electrolyte layer, a metallic forming body which is compressed after being form-molded, the metallic forming body being stacked on at least one of the first and second electrode layers, and the metallic forming body supplying reaction gas to at least one of the electrode layers through inner pores, and a bipolar plate stacked on the metallic forming body.

In some embodiments, the fuel cell may further include a gas diffusion layer disposed between at least one electrode layer of the first electrode layer and second electrode layer and the compressed metallic forming body.

In some embodiments, the gas diffusion layer may be formed of a microporous layer (MPL).

In some embodiments, the metallic forming body may be compressed to have porosity of 85% or more.

In some embodiments, the fuel cell may further include a separate metallic forming body between the compressed metallic forming body and the bipolar plate, the separate metallic forming body supplying reaction gas to the compressed metallic forming body through pores.

In some embodiments, the separate metallic forming body may have greater porosity than the compressed metallic forming body.

In some embodiments, the separate metallic forming body may be a metallic forming body which is uncompressed after being form-molded.

In some embodiments, the separate uncompressed metallic forming body may have porosity of at least 90%.

In another aspect, the present disclosure provides a method of manufacturing a fuel cell including forming membrane electrode assembly including a first electrode layer formed at one side of an electrolyte layer and a second electrode layer formed at another side of the electrolyte layer, forming a metallic forming body compressed after being form-molded, stacking the compressed forming body on at least one of the first electrode layer and the second electrode layer such that the compressed forming body supplies reaction gas to the electrode layer through pores, and stacking a bipolar plate on the metallic forming body.

In some embodiments, the method further may include forming a gas diffusion layer formed of a microporous layer (MPL) between at least one of the electrode layers and the compressed metallic forming body.

In some embodiments, the form-molded metallic forming body may be compressed to have porosity of 85% or more according to a predetermined amount of compression.

In some embodiments, the method further may include forming a separate metallic forming body supplying reaction gas to the compressed metallic forming body through pores between the compressed metallic forming body and the bipolar plate.

In some embodiments, the separate metallic forming body may have greater porosity than the compressed metallic forming body.

In some embodiments, the separate metallic forming body may be a metallic forming body which is uncompressed after being form-molded.

In some embodiments, the separate uncompressed metallic forming body may have porosity of at least 90%.

Other aspects and preferred embodiments of the disclosure are discussed infra.

It is understood that the terms “vehicle”, “vehicular” and other similar terms as used herein are inclusive of motor vehicles in general such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a view illustrating a cell structure of a fuel cell according to a first exemplary embodiment of the present disclosure;

FIG. 2 is a view illustrating voltage of an open circuit of the cell of the fuel cell according to the embodiment of FIG. 1;

FIG. 3 is a view illustrating a cell structure of a fuel cell according to a second exemplary embodiment of the present disclosure;

FIG. 4 is a view illustrating voltage of an open circuit of the cell of the fuel cell according to the embodiment of FIG. 3;

FIG. 5 is a flowchart sequentially illustrating a method of manufacturing the fuel cell according to the embodiment of FIG. 1;

FIG. 6 is a flowchart sequentially illustrating a method of manufacturing the fuel cell according to the embodiment of FIG. 3.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments according to the present disclosure are described in detail with reference to the accompanying drawings.

Advantages and features of the present disclosure, and method for achieving thereof will be apparent with reference to the examples that follow.

However, it should be understood that the present disclosure is not limited to the following embodiments and may be embodied in different ways, and that the embodiments are given to provide complete disclosure of the disclosure and to provide thorough understanding of the disclosure to those skilled in the art, and the scope of the disclosure is limited only by the accompanying claims and equivalents thereof.

In addition, when describing embodiments of the present disclosure, detailed descriptions of well-known functions and structures incorporated herein may be omitted when they make the subject matter of the present disclosure unclear.

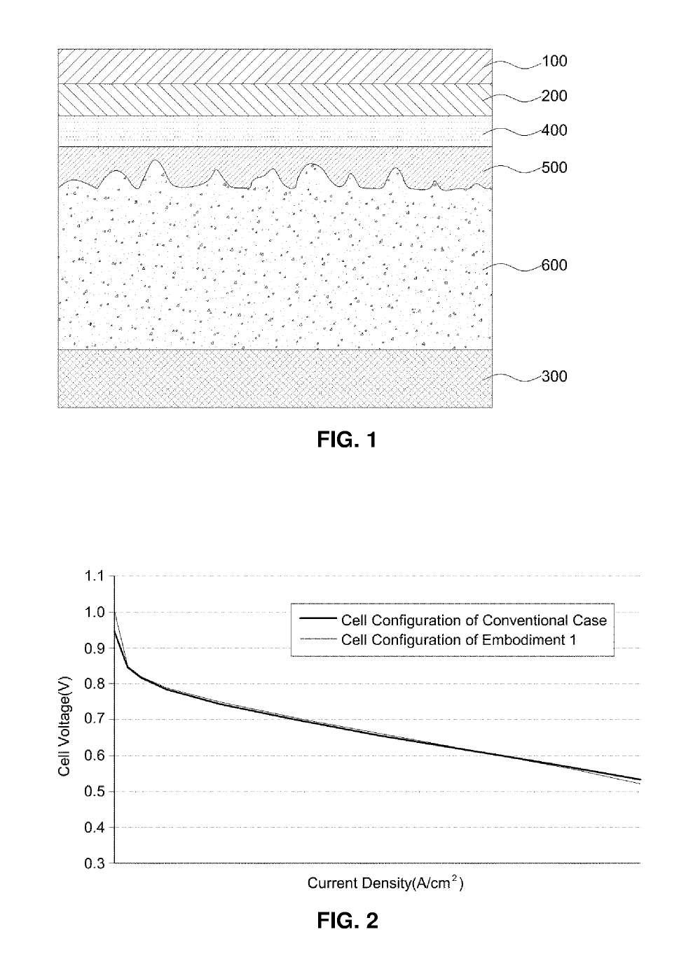

FIG. 1 is a view illustrating a cell structure of a fuel cell according to a first embodiment of the present disclosure. FIG. 2 is a view illustrating voltage of an open circuit of the cell of the fuel cell according to the first embodiment of the present disclosure.

In the first embodiment of the present disclosure, as illustrated in FIG. 1, a unit cell of the fuel cell may include a membrane electrode assembly including a first electrode layer formed at one side of an electrolyte layer 100 and a second electrode layer formed at the other side of the electrolyte layer 100, a compressed metallic forming body 500 stacked on at least one of the first and second electrode layers 200 and supplying reaction gas to at least one of the electrode layers 200 through inner pores, and a bipolar plate 300 stacked on the metallic forming body 500.

A gas diffusion layer may be further stacked between at least one of the electrode layers 200 and the compressed metallic forming body 500. The gas diffusion layer may be formed of microporous layer (MPL) 400.

Instead of the conventional gas diffusion layer at the outer surfaces of the first and second electrode layers, the microporous layer (MPL) 400 is stacked. The metallic forming body 500 is disposed between the microporous layer 400 and the bipolar plate 300.

Furthermore, according to the first embodiment of the present disclosure, the fuel cell may further include a separate metallic forming body 600 providing a response flow path between the compressed metallic forming body 500 and the bipolar plate 300.

Herein, the flow path is removed from the bipolar plate 300. Since the entire outer surface of the separate metallic forming body 600 uniformly adheres to the bipolar plate 300, a surface of the bipolar plate which adheres to a surface of the metallic forming body 600 may be flat.

Hereinafter, in the present disclosure, the compressed metallic forming body 500 is referred to as a first metallic forming body and the separate metallic forming body 600 is referred to as a second metallic forming body.

According to the first embodiment of the present disclosure, in the fuel cell, the first metallic forming body 500 and the second metallic forming body 600 are sequentially stacked between the microporous layer 400 and the bipolar plate 300.

In this case, since the conventional gas diffusion layer is replaced with the microporous layer 400, production costs of the fuel cell may be reduced and a voltage generation of an open circuit may be improved.

Furthermore, the porous metallic forming body may be applied in order to improve a diffusion of reaction gas and discharge of water in the cell of the fuel cell. When the metallic forming body in an initial state (uncompressed state) in which the metallic forming body is uncompressed after being form-molded is directly applied, damage to a component in contact with the metallic forming body may be caused due to a high surface roughness of the metallic forming body.

Accordingly, the gas diffusion layer having a thickness of hundreds of micrometers in the cell structure of the fuel cell may function as a buffer which is capable of preventing damage to the membrane electrode assembly. In this case, the thickness of the gas diffusion layer is large such that the volume of the fuel cell stack is increased. Accordingly, an output density of the fuel cell stack may be decreased.

Thus, according to the present disclosure, as the gas diffusion layer formed of the microporous layer 400 having a smaller thickness than the conventional gas diffusion layer is substituted for the general gas diffusion layer constituting the conventional fuel cell, an output density of the fuel cell stack according to volume decrease of the fuel cell stack is increased. The high-priced gas diffusion layer according to the conventional case may be removed, thereby reducing manufacturing costs of the fuel cell stack.

Meanwhile, in the illustrated embodiment, after being form-molded, the first metallic forming body 500 compressed to have a predetermined thickness range and the second metallic forming body 600 supplying one of the first reaction gas and the second reaction gas to the first metallic forming layer 500 through the inner pores are sequentially stacked between the gas diffusion layer formed of the microporous layer 400 and the bipolar plate 300.

Herein, the first metallic forming body 500 compressed after being form-molded is in a compressed state. The first metallic forming body 500 may be stacked with at least one electrode layer 200 of the first and second electrode layers. Herein, the microporous layer 400 may be disposed between the first metallic forming body 500 and the electrode layer 200.

The first metallic forming body 500 supplies reaction gas to the microporous layer 400 and the electrode layer 200 through the pores.

Herein, the inner pores are provided as the flow path of the reaction gas such that the second metallic forming body 600 supplying reaction gas to the first metallic forming body 500 through the inner pores may be an uncompressed metallic forming body.

When the second metallic forming body 600, which is a metallic forming body in an initial state without compression, namely an uncompressed metallic forming body while being capable of distributing and supplying the first and second reaction gases in vertical and horizontal directions, is only stacked between the microporous layer 400 and the bipolar plate 300, damage to the membrane electrode assembly and the microporous layer 400 due to high surface roughness of the second metallic forming body 600 may be generated.

As a result, according to exemplary embodiments, after being form-molded, the metallic forming body in the initial state is compressed by a press or a roller to form the first metallic forming body 500 in a compressed state. The first metallic forming body 500 is disposed between the second metallic forming body 600 and the microporous layer 400.

Herein, the first metallic forming body 500 may be fully and maximally compressed to have a minimum thickness in which elastic restoring force is not generated, such that the first metallic forming body 500 may be a metallic forming body in a completely compressed state.

That is, the first metallic forming body 500 is compressed in a thickness direction to collapse the pores after being form-molded such that the first metallic forming body 500 is a metallic forming body in a compressed state. Upon compression, the first metallic forming body 500 is compressed until a thickness change due to a collapse of the pores does not occur. Thereby, the collapsed pores at a surface of the first metallic forming body 500 may be connected to one another in a thickness direction to be a metallic forming body in a completely compressed state while forming a flow path using, or for, gas.

In the first metallic forming body 500 in the completely compressed state, the pores are completely collapsed in a thickness direction and the collapsed pores at the surface are connected to one another in a thickness direction. Thus, reaction gas may pass through the pores in a vertical direction, namely, in a thickness direction of the metallic forming body 500.

The first metallic forming body 500 is stacked at the microporous layer 400, such that the surface of the uncompressed second metallic forming body 600 is not directly in contact with the surface of the microporous layer 400.

Since the first metallic forming body 500 in the compressed state has a smooth surface in comparison with the second metallic forming body 600 in the uncompressed state, damage to the microporous layer 400 and the membrane electrode assembly may be prevented when the first metallic forming body 500 adheres to the microporous layer 400 and is stacked on the microporous layer 400 in a contact state.

In detail, after being form-molded, the metallic forming body in an initial state is completely compressed such that a surface roughness of the metallic forming body may be even. Since the completely compressed first metallic forming body 500 may prevent the microporous layer 400 from being directly in contact with the second metallic forming layer 600, damage to the membrane electrode assembly and the microporous layer 400 due to high surface roughness of the second metallic forming body 600 may be prevented.

Herein, since the first forming body 500 is stacked in a completely compressed state, the first reaction gas or second reaction gas passing through the pores may be supplied to the microporous layer 400 in a vertical direction, namely, in a thickness direction of the metallic forming body 500.

As a result, in exemplary embodiments, in the cell structure of the fuel cell, as the first metallic forming body 500 is applied in a completely compressed state, damage to the membrane electrode assembly and the microporous layer 400 due to high surface roughness of the second metallic forming layer 600 may be prevented. As illustrated in FIG. 2, open circuit voltage is higher than in the cell of the conventional fuel cell.

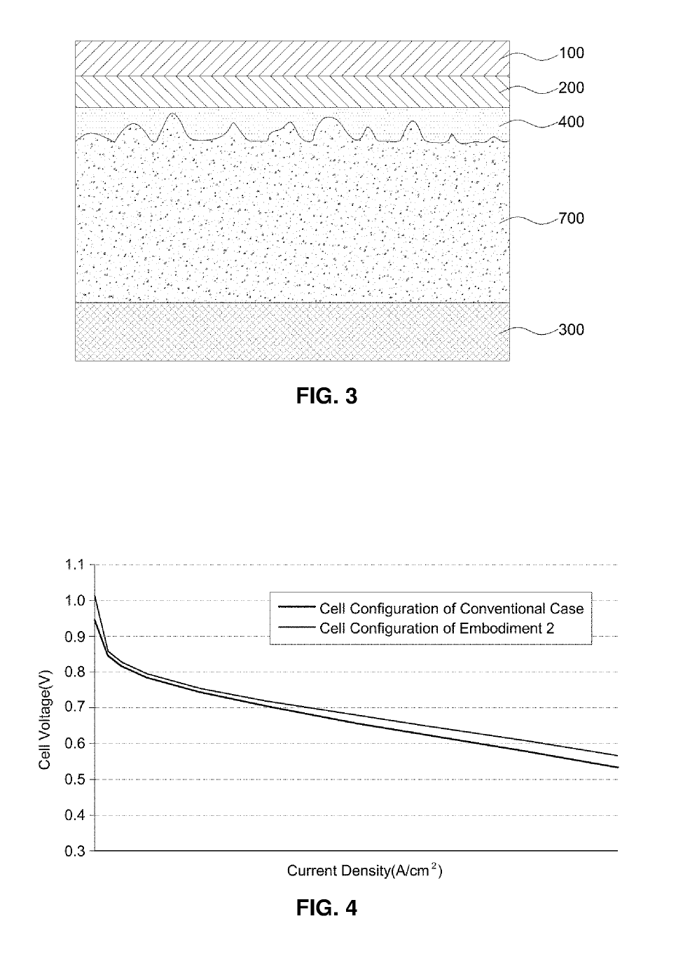

FIG. 3 is a view illustrating a cell structure of a fuel cell according to a second exemplary embodiment of the present disclosure. FIG. 4 is a view illustrating a voltage of an open circuit of the cell of the fuel cell according to the second embodiment of the present disclosure.

As illustrated in FIG. 3, in a unit cell, a metallic forming body in an initial state, namely, an uncompressed metallic forming body after being form-molded without compression, is compressed according to a predetermined amount of compression in a thickness direction thereof to have certain porosity, thereby forming a metallic forming body 700. The fuel cell according to the second embodiment of the present disclosure includes the metallic forming body 700 between a bipolar plate 300 and a microporous layer 400.

Herein, detailed description of the membrane electrode assembly including the electrolyte layer 100 and the electrode layer 200 and the gas diffusion layer including the bipolar plate 300 and the microporous layer 400 is omitted since there is no difference from that of the first embodiment.

According to the second embodiment of the present disclosure, in the fuel cell, the metallic forming body 700 is stacked on the microporous layer 400 to adhere thereto, and the metallic forming body 700 is compressed to have a predetermined porosity, such that the metallic forming body 700 in a compressed state supplies the first reaction gas or second reaction gas to the microporous layer 400 through the inner pores. Thereby, the first reaction gas or the second reaction gas is supplied to the electrode layer forming a catalyst layer of the membrane electrode assembly through the microporous layer 400, namely, at least one electrode layer 200 of the first electrode layer and the second electrode layer.

In the fuel cell of the first and second embodiments of the present disclosure, the metallic forming body compressed after being form-molded is used in a compressed state. However, the metallic forming body 700 of the fuel cell according to the second embodiment is partially compressed in comparison with the completely compressed first metallic forming body 500 according to the first embodiment.

That is, the metallic forming body 700 of the second embodiment is partially compressed at a predetermined amount of compression to maintain the predetermined thickness and porosity. The first reaction gas or the second reaction gas passing through the pores of the metallic forming body 700 may be distributed and supplied in a vertical direction (i.e., a thickness direction of the forming body) and a horizontal direction (i.e., a longitudinal direction of the forming body). Herein, the metallic forming body 700 may be manufactured to have a porosity of 85% or more by compression.

The metallic forming body 700 may be manufactured to have porosity of 85% to 90% by compression. When porosity is less than 85% due to excessive compression, it is difficult for the reaction gas to access and pass through the inner pores. Thereby, performance of the fuel cell is decreased.

Furthermore, when the metallic forming body 700 in a compressed state has porosity of more than 90%, it is difficult to achieve the objective of the disclosure and to obtain required effects according to a use of the metallic forming body.

That is, when porosity is over 90%, the surface of the metallic forming body 700 is excessively rough such that a component which is directly in contact with the metallic forming body may be damaged by high surface roughness. In this case, a voltage loss of the open circuit may still be generated.

Accordingly, in the first embodiment, damage to a component of the cell of the fuel cell is prevented by sequential stacking of the first metallic forming body 500 and the second metallic forming body 600. However, in the second embodiment, the metallic forming body 700, which is partially compressed at the certain amount of the compression while being not completely compressed to maintain the predetermined thickness and porosity and to have uniform surface roughness after being form-molded, is used, thereby preventing damage to the cell component of the fuel cell.

That is, the metallic forming body in the initial state is compressed to have a porosity of about 85% or more such that a surface roughness of the metallic forming body may be adjusted. The compressed metallic forming body 700 is stacked between the bipolar plate 300 and the microporous layer 400 such that surface damage to the component of the cell of the fuel cell due to a surface roughness of the metallic forming body 700 may be prevented.

Thus, in the fuel cell according to the second embodiment of the present disclosure, the compressed metallic forming body having a certain porosity is applied such that damage to the membrane electrode assembly and the microporous layer 400 due to high surface roughness of the metallic forming body in the initial state may be prevented. As illustrated in FIG. 4, the cell of the fuel cell may have high open circuit voltage in comparison with the cell of the conventional fuel cell.

Hereinafter, a method of manufacturing a fuel cell according to exemplary embodiments of the present disclosure will be explained.

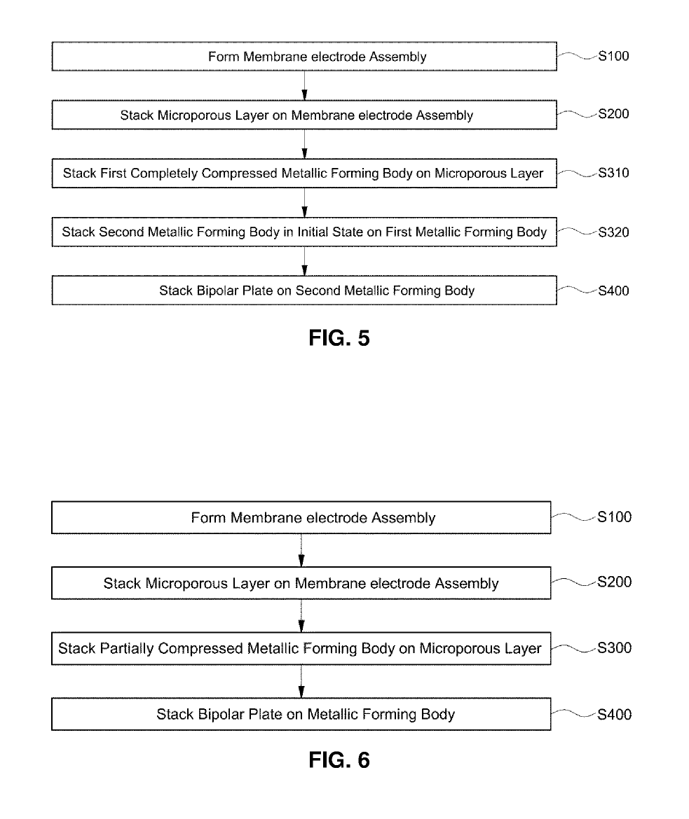

FIG. 5 is a flowchart sequentially illustrating a method of manufacturing the fuel cell according to the first embodiment of the present disclosure. FIG. 6 is a flowchart sequentially illustrating a method of manufacturing the fuel cell according to the second embodiment of the present disclosure.

First, the method of manufacturing the fuel cell according to the first embodiment of the present disclosure will be explained. As illustrated in FIG. 5, the electrode layers, namely, the first electrode layer and the second electrode layer are formed at both sides of the electrolyte layer 100 to form the membrane electrode assembly (S100).

The gas diffusion layer formed of the microporous layer 400 may be stacked with at least one electrode layer 200 of the first and second electrode layers. For example, the microporous layers 400 may be stacked at both of the first and second electrode layers, respectively (S200).

In the cell structure of the conventional fuel cell, the conventional thick gas diffusion layer is stacked on the first and second electrode layers. The gas diffusion layer may cause the fuel cell stack to have a large volume due to the thickness of the gas diffusion layer, thereby decreasing output density of the fuel cell stack.

Thus, according to exemplary embodiments of the present disclosure, the conventional thick gas diffusion layer is removed and the gas diffusion layer formed of the microporous layer 400 is stacked instead of the thick gas diffusion layer.

Thereafter, in terms of stacking the compressed metallic forming body, the metallic forming body in the initial state is maximally compressed to have a minimum thickness in a thickness direction after being form-molded, thereby preparing the first metallic forming body 500 in the completely compressed state. The compressed metallic forming body 500 having uniform surface roughness is stacked on the surface of the microporous layer 400 (S310).

Herein, the predetermined minimum thickness is referred to as a thickness of the completely compressed forming body in a thickness direction until a thickness change does not occur due to a collapse of the pores in a thickness direction upon compression. The predetermined minimum thickness is referred to as a thickness of the completely compressed forming body which is compressed by a press or a roller to have a minimum thickness until a thickness change does not occur. The predetermined minimum thickness is referred to as a thickness of the metallic forming body in which the metallic forming body in the initial state is completely compressed not to generate, or without generating, elastic restoring forces.

The metallic forming body in the initial state having high surface roughness is compressed such that the completely compressed metallic forming body has a uniform surface roughness.

Then, the metallic forming body in the initial state, namely, the uncompressed second forming body 600 as described in the first embodiment of the present disclosure, is stacked on the first metallic forming body 500 (S320).

Herein, the second metallic forming body 600 is the uncompressed metallic forming body in the initial state while having porosity of about 90% or more. The second metallic forming body may smoothly distribute and supply reaction gas through the inner pores, which are not collapsed, to the first metallic forming body 500 in a vertical direction (a thickness direction of the forming body) and a horizontal direction (a longitudinal direction of the forming body).

A metallic forming body having porosity of 90 to 97% may be used as the second metallic forming body 600 in the uncompressed state.

Herein, when the second metallic forming body 600 is formed to have a porosity of less than 90% after being form-molded and the inner pores of the second metallic forming body are used as a flow path for supplying a reaction gas, it is difficult to supply reaction gas due to low porosity. Thus, performance of the fuel cell is decreased.

Furthermore, when the initial forming body without compression after being form-molded is used as the second metallic forming body 600, the uncompressed metallic forming body is thicker than the compressed metallic forming body. The second metallic forming body should be manufactured to satisfy strength requirements and to be sufficiently thin.

However, due to characteristics of the metallic forming body and the method of manufacturing the same, in form-molding the metallic forming body, it is difficult for the initial forming body to be manufactured to have porosity of more than 97%. Despite having porosity of more than 97%, since strength is low, it is difficult to use with the fuel cell.

Since the second metallic forming body 600 has a high surface roughness, when the second metallic forming body 600 is directly stacked on the microporous layer 400, damage to the membrane electrode assembly and the microporous layer 400 may be generated. As the illustrated embodiment, however, above-described damage may be prevented through stacking of the compressed first metallic forming body 500. Thereby, the fuel cell of the illustrated embodiment may have a higher open circuit voltage than the conventional fuel cell.

After stacking the second metallic forming body 600, the bipolar plate 300 is stacked at the surface of the second metallic forming body 600 to form the fuel cell (S400).

Hereafter, a method of manufacturing the fuel cell according to the second embodiment of the present disclosure will be explained. As illustrated in FIG. 6, the electrode layers, namely, the first electrode layer and the second electrode layer are formed at both sides of the electrolyte 100 to form the membrane electrode assembly (S100).

Then, the gas diffusion layer formed of the microporous layer 400 may be stacked on at least one electrode layer 200 of the first electrode layer and the second electrode layer. For example, the microporous layers 400 may be stacked on both the first and second electrode layers (S200).

After being form-molded, the metallic forming body is compressed to have a porosity of about 85% or more to form the compressed metallic forming body 700. The compressed metallic forming body 700 adheres to the microporous layer 400 to be stacked thereon (S300).

Lastly, the bipolar plate 300 is stacked on the surface of the compressed metallic forming body 700 to form the cell of the fuel cell (S400).

According to the present disclosure, among the components of the cell of the fuel cell, the gas diffusion layer formed of the microporous layer, the metallic forming body providing a reaction flow path, and the bipolar plate without the reaction flow path are applied instead of the general, or conventional, gas diffusion layer and the bipolar plate having the reaction flow path according to the conventional case. Particularly, the compressed metallic forming body after being form-molded is applied such that damage to the membrane electrode assembly due to use of the uncompressed metallic forming body may be prevented. Thereby, a voltage loss of the conventional open circuit may be improved.

Furthermore, according to the present disclosure, instead of the conventional, thick, and high-priced gas diffusion layer, the microporous layer may be used such that manufacturing costs may be reduced. Meanwhile, the volume of the fuel cell stack may be decreased, thereby increasing output density of the fuel cell stack.

As apparent from the above description, in accordance with the present disclosure, when the compressed metallic forming body is applied to the fuel cell, damage to the membrane electrode assembly due to high surface roughness of the conventional metallic forming body may be prevented. Furthermore, a voltage loss of the open circuit may be improved.

Furthermore, as the microporous layer (MPL) is used instead of the conventional gas diffusion layer, production costs of the fuel cell stack may be reduced. Meanwhile, a volume of the fuel cell stack is reduced and output density is increased.

As described above, exemplary embodiments have been disclosed in this specification and the accompanying drawings. Although specific terms are used herein, they are merely used for describing the present disclosure, but do not limit the meanings and the scope of the present disclosure disclosed in the claims. Accordingly, a person having ordinary knowledge in the technical field of the present disclosure will appreciate that various modifications and other equivalent embodiments can be derived from the exemplary embodiments of the present disclosure. Therefore, the scope of technical protection of the present disclosure is defined by the technical ideas of the appended claims.

What is claimed is:

1. A fuel cell comprising:
a membrane electrode assembly including a first electrode layer formed at one side of an electrolyte layer and a second electrode layer formed at another side of the electrolyte layer;
a metallic forming body compressed after being form-molded, the metallic forming body being stacked on at least one of the first and second electrode layers, and the metallic forming body supplying reaction gas to at least one of the electrode layers through inner pores; and
a bipolar plate stacked on the metallic forming body.

2. The fuel cell according to claim 1, further comprising a gas diffusion layer disposed between at least one electrode layer, of the first electrode layer and the second electrode layer, and the compressed metallic forming body.

3. The fuel cell according to claim 2, wherein the gas diffusion layer is formed of a microporous layer (MPL).

4. The fuel cell according to claim 1, wherein the metallic forming body is compressed to have a porosity of 85% or more.

5. The fuel cell according to claim 1, further comprising a separate metallic forming body between the compressed metallic forming body and the bipolar plate, the separate metallic forming body supplying reaction gas to the compressed metallic forming body through one or more pores.

6. The fuel cell according to claim 5, further comprising a gas diffusion layer between the compressed metallic forming body and at least one of the first and second electrode layers.

7. The fuel cell according to claim 6, wherein the gas diffusion layer is formed of a microporous layer (MPL).

8. The fuel cell according to claim 5, wherein the separate metallic forming body has greater porosity than the compressed metallic forming body.

9. The fuel cell according to claim 5, wherein the separate metallic forming body is a metallic forming body which is uncompressed after being form-molded.

10. The fuel cell according to claim 9, wherein the separate metallic forming body has porosity of at least 90%.

11. The fuel cell according to claim 5, wherein:
the compressed metallic forming body is compressed in a thickness direction to collapse the pores; and
the compressed metallic forming body is compressed until a thickness thereof is not changed due to a collapse of the pores to form a gas flow path in which collapsed pores are connected to one another in a thickness direction such that the metallic forming body is in a completely compressed state.

12. A method of manufacturing a fuel cell comprising:
forming membrane electrode assembly including a first electrode layer formed at one side of an electrolyte layer and a second electrode layer formed at another side of the electrolyte layer;
forming a metallic forming body compressed after being form-molded;
stacking the compressed forming body on at least one of the first and second electrode layers such that the compressed forming body supplies reaction gas to the electrode layer through pores; and
stacking a bipolar plate on the metallic forming body.

13. The method of manufacturing the fuel cell according to claim 12, further comprising stacking a gas diffusion layer formed of a microporous layer (MPL) between at least one of the electrode layers and the compressed metallic forming body.

14. The method of manufacturing the fuel cell according to claim 12, wherein the form-molded metallic forming body is compressed to have a porosity of 85% or more according to a predetermined amount of compression.

15. The method of manufacturing the fuel cell according to claim 12, further comprising stacking a separate metallic forming body supplying reaction gas to the compressed metallic forming body through one or more pores between the compressed metallic forming body and the bipolar plate.

16. The method of manufacturing the fuel cell according to claim 15, further comprising stacking a gas diffusion layer formed of a microporous layer (MPL) between the compressed metallic forming body and at least one of the first and second electrode layers.

17. The method of manufacturing the fuel cell according to claim 15, wherein the separate metallic forming body has a greater porosity than the compressed metallic forming body.

18. The method of manufacturing the fuel cell according to claim 15, wherein the separate metallic forming body is a metallic forming body which is uncompressed after being form-molded.

19. The method of manufacturing the fuel cell according to claim 15, wherein the separate metallic forming body has a porosity of at least 90%.

20. The method of manufacturing the fuel cell according to claim 19, wherein:
the compressed metallic forming body is compressed in a thickness direction to collapse the pores; and
the compressed metallic forming body is compressed until a thickness thereof is not changed due to a collapse of the pores in a thickness direction, to form a gas flow path in which collapsed pores are connected to one another in a thickness direction such that the metallic forming body is in a completely compressed state.
